(19) United States
(12) Patent Application Publication
(10) Pub. No.: US 2023/0418578 A1
(43) Pub. Date: Dec. 28, 2023

(54) SYSTEMS AND METHODS FOR DETECTION OF CODE CLONES

(71) Applicant: Huawei Technologies Co., Ltd., Shenzhen (CN)

(72) Inventors: Jinfu CHEN, Montreal (CA); Yuan WANG, Kingston (CA); Dong QIU, Hangzhou (CN); Xin XIA, Hangzhou (CN)

(21) Appl. No.: 18/463,956

(22) Filed: Sep. 8, 2023

Related U.S. Application Data
(63) Continuation of application No. PCT/CN2021/115181, filed on Aug. 28, 2021.

(51) Int. Cl. G06F 8/41; G06F 8/73

(52) U.S. Cl. CPC G06F 8/443; G06F 8/73

(57) ABSTRACT

Methods and devices are described for detecting code clones in a software program. The source code of the software program is processed into a group of n-gram representations. A clone index is generated for each respective code portion defined in the normalized source code, where each clone index includes a feature vector encoding features of the respective code portion based on the n-gram representations corresponding to the respective code portion. Comparison of the clone indexes is used to detect a code clone, based on matching the feature vectors of the clone indexes.

### CROSS-REFERENCE TO RELATED APPLICATIONS

The present disclosure is a continuation application of International Application No. PCT/CN2021/115181 entitled “SYSTEMS AND METHODS FOR DETECTION OF CODE CLONES”, filed Aug. 28, 2021, the entirety of which is hereby incorporated by reference.

### TECHNICAL FIELD

The present disclosure relates to systems and methods for detecting a code clone, in particular systems and methods for detecting code clones at different levels of abstraction and/or granularity.

### BACKGROUND

Code clones (also referred to as duplicate code) are code fragments that are identical or similar to each other. A code fragment is a sequence of source code lines. Two code fragments may be considered to be clones of each other without being exactly identical. For example, two code fragments that differ only in the use of whitespace characters and/or comments (or other non-functional lines of code) may be considered to be clones of each other. Two code fragments that are similar to each other at a higher level of abstraction (e.g., identical to each other in function, rather than being exactly identical on a character level) may also be considered to be code clones.

Detection of code clones is important for software tasks such as code searching, refactoring, and bug detection. Detection of code clones is often important because code clones may reduce software performance (e.g., resulting in larger code files, thus requiring more memory and processor resources to store and/or compile the code). Code clones also result in software that is more complex to maintain (e.g., an update to the software may require updating all instances of a cloned code fragment). Further, code clones present a risk that a software vulnerability is repeated in the software and may be missed when attempting to fix the vulnerability. Existing code clone detection techniques typically are designed to detect only certain types of code clones. Further, existing techniques typically are suitable for relatively small software (e.g., having tens of thousands lines of code) and are not scalable for use with larger software (e.g., having millions of lines of code).

Accordingly, it would be useful to provide a solution that can detect the code clones in software, which is practical for different types of code clones and/or different software sizes.

### SUMMARY

In various examples, the present disclosure describes systems and methods that enable detection of code clones at different levels of abstraction and at different levels of granularity.

Examples of the present disclosure enable detection of code clones at different levels of abstraction and different levels of granularity. A clone index database is populated with clone indexes that are generated from n-gram representations of lines of code. This provides the technical advantage that line-level detection of code clones is possible, as well as the advantage that the disclosed systems and methods are scalable for analysis of larger software programs.

In some examples, the disclosed systems and methods may be implemented as a service (e.g., a cloud-based service) that provides code clone detection and generates a report to clients.

In some examples, the disclosed systems and methods enable creation and maintenance of a clone index, which may be used to detect known code clones in a single file, across multiple files, or across software systems, for example.

The disclosed systems and methods may enable detection of code clones that are possible software vulnerabilities or possible malicious code. The disclosed systems and methods may also enable detection of code plagiarism or copyright infringement. The disclosed systems and methods may also enable detection of widely-cloned code fragments that may be suitable candidates for a code library.

In an example aspect, the present disclosure describes a method including: obtaining a software program comprising source code; processing the source code into groups of n-gram representations, each group of n-gram representation corresponding to a respective line of code in the source code; generating a clone index for each respective code portion defined in the source code, each respective code portion comprising a defined number of lines of code, wherein each clone index includes a feature vector encoding features of the respective code portion based on the n-gram representations corresponding to the respective code portion; and detecting a code clone based on matching the feature vectors of the clone indexes by comparing the clone indexes.

In an example of the preceding example aspect of the method, the method may further include: outputting a code clone report including an entry indicating the detected code clone.

In an example of any of the preceding example aspects of the method, processing the source code into the groups of n-gram representations may include: processing the source code into formatted source code having a common format; converting the formatted source code into abstracted source code according to an abstraction level; normalizing the abstracted source code into normalized source code comprising token sequences, wherein each token sequence corresponds to a respective line of code in the normalized source code and wherein each line of code in the normalized source code corresponds to a respective line of code in the source code; and generating, for each token sequence, the group of n-gram representations corresponding to the respective line of code.

In an example of the preceding example aspect of the method, converting the formatting source code into the abstracted source code may include: obtaining a selection of the abstraction level, wherein the abstraction level defines one or more types of identifiers in the formatted source code to be replaced with respective generic labels; and replacing the defined one or more types of identifiers in the formatted source code with the respective generic labels, to obtain the abstracted source code.

In an example of the preceding example aspect of the method, the abstraction level may be selectable by user input.

In an example of any of the preceding example aspects of the method, the defined number of lines of code may be selectable by user input.

In an example of any of the preceding example aspects of the method, generating the clone index for a given code portion may include generating the feature vector encoding features of the given code portion, where generating the feature vector may include: extracting features from the given code portion based on the n-gram representations corresponding to the given code portion; for each feature, generating a respective weighted hash vector; and combining the weighted hash vectors into a combined vector for use as the feature vector.

In an example of the preceding example aspect of the method, extracting features from the given code portion may include: obtaining a collection of n-gram representations corresponding to the given code portion by collecting the group of n-gram representations corresponding to each line of code belonging to the given code portion; and extracting the features from the given code portion, wherein each n-gram representation in the collection of n-gram representations is a feature of the given code portion, and wherein a count of each feature within the collection of n-gram representations is a respective weight.

In an example of any of the preceding example aspects of the method, generating the respective weighted hash vector for each feature may include: for each feature, generating a respective hash vector using a hash algorithm; and for each hash vector corresponding to a respective feature, applying the respective weight to obtain the respective weighted hash vector.

In an example of any of the preceding example aspects of the method, the combined vector may be further converted to a binary combined vector for use as the feature vector.

In an example of any of the preceding example aspects of the method, the clone index for a given code portion may include an identifier of the source code, an indicator of a location of the given code portion in the source code, and the feature vector encoding features of the given code portion.

In an example of any of the preceding example aspects of the method, each code portion defined in the source code may be defined by using a sliding window, and the defined number of lines of code in each code portion may be defined by a size of the sliding window.

In an example of any of the preceding example aspects of the method, the method may include: storing the clone indexes in a clone index database.

In an example of any of the preceding example aspects of the method, detecting the code clone may include comparing the clone indexes associated with the software program with clone indexes associated with another software program.

In some example aspects, the present disclosure describes a device including a processing unit configured to execute instructions to cause the device to: process the source code into groups of n-gram representations, each group of n-gram representation corresponding to a respective line of code in the source code; generate a clone index for each respective code portion defined in the source code, each respective code portion comprising a defined number of lines of code, wherein each clone index includes a feature vector encoding features of the respective code portion based on the n-gram representations corresponding to the respective code portion; and detect a code clone based on matching the feature vectors of the clone indexes by comparing the clone indexes.

In an example of the preceding example aspect of the device, the processing unit may be configured to execute the instructions to further cause the device to: output a code clone report including an entry indicating the detected code clone.

In an example of any of the preceding example aspects of the device, the processing unit may be configured to execute the instructions to further cause the device to process the source code into the groups of n-gram representations by: processing the source code into formatted source code having a common format; converting the formatted source code into abstracted source code according to an abstraction level; normalizing the abstracted source code into normalized source code comprising token sequences, wherein each token sequence corresponds to a respective line of code in the normalized source code and wherein each line of code in the normalized source code corresponds to a respective line of code in the source code; and generating, for each token sequence, the group of n-gram representations corresponding to the respective line of code.

In an example of the preceding example aspect of the device, the processing unit may be configured to execute the instructions to further cause the device to convert the formatting source code into the abstracted source code by: obtaining a selection of the abstraction level, wherein the abstraction level defines one or more types of identifiers in the formatted source code to be replaced with respective generic labels; and replacing the defined one or more types of identifiers in the formatted source code with the respective generic labels, to obtain the abstracted source code.

In an example of the preceding example aspect of the device, the abstraction level may be selectable by user input.

In an example of any of the preceding example aspects of the device, the defined number of lines of code may be selectable by user input.

In an example of any of the preceding example aspects of the device, the processing unit may be configured to execute the instructions to further cause the device to generate the clone index for a given code portion by generating the feature vector encoding features of the given code portion, where generating the feature vector may include: extracting features from the given code portion based on the n-gram representations corresponding to the given code portion; for each feature, generating a respective weighted hash vector; and combining the weighted hash vectors into a combined vector for use as the feature vector.

In an example of the preceding example aspect of the device, the processing unit may be configured to execute the instructions to further cause the device to extract features from the given code portion by: obtaining a collection of n-gram representations corresponding to the given code portion by collecting the group of n-gram representations corresponding to each line of code belonging to the given code portion; and extracting the features from the given code portion, wherein each n-gram representation in the collection of n-gram representations is a feature of the given code portion, and wherein a count of each feature within the collection of n-gram representations is a respective weight.

In an example of any of the preceding example aspects of the device, the processing unit may be configured to execute the instructions to further cause the device to generate the respective weighted hash vector for each feature by: for each feature, generating a respective hash vector using a hash algorithm; and for each hash vector corresponding to a respective feature, applying the respective weight to obtain the respective weighted hash vector.

In an example of any of the preceding example aspects of the device, the combined vector may be further converted to a binary combined vector for use as the feature vector.

In an example of any of the preceding example aspects of the device, the clone index for a given code portion may include an identifier of the source code, an indicator of the location of the given code portion in the source code, and the feature vector encoding features of the given code portion.

In an example of any of the preceding example aspects of the device, each code portion defined in the source code may be defined by using a sliding window, and the defined number of lines of code in each code portion may be defined by a size of the sliding window.

In an example of any of the preceding example aspects of the device, the processing unit may be configured to execute the instructions to further cause the device to: store the clone indexes in a clone index database.

In an example of any of the preceding example aspects of the device, the processing unit may be configured to execute the instructions to further cause the device to detect the code clone by comparing the clone indexes associated with the software program with clone indexes associated with another software program.

In another example aspect, the present disclosure describes a computer readable medium having instructions encoded thereon, wherein the instructions, when executed by a processing unit of a system, cause the system to perform any of the preceding example aspects of the method.

In another example aspect, the present disclosure describes a computer program including instructions which, when the program is executed by a computer, cause the computer to carry out any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram illustrating an example code clone detection system, in accordance with examples of the present disclosure;

FIG. 2 is a block diagram illustrating an example computing device that may be used to implement a code clone detection system, in accordance with examples of the present disclosure;

FIG. 3 is a flowchart of an example method that may be performed using the code clone detection system, for detection of code clones in a software program;

FIG. 4 illustrates some example abstraction levels that may be used in method of FIG. 3;

FIG. 5 is a flowchart of an example method for generating a clone index, which may be used in the method of FIG. 3;

FIG. 6 illustrates an example of how a feature vector may be generated from a code portion, in accordance with the method of FIG. 5;

FIG. 7 illustrates an example of different clone indexes that may be generated for different code portions, in accordance with the method of FIG. 5; and

FIG. 8 illustrates an example of how a code fragment may be detected to be a code clone, in accordance with the example of FIG. 3.

Similar reference numerals may have been used in different figures to denote similar components.

### DETAILED DESCRIPTION

To assist in understanding the present disclosure, some terminology is first introduced. A code fragment is a sequence of one or more lines of code in a software program. Code clones are two or more code fragments that are identical or similar to each other. Code clones can be categorized into four types as follows. A first type of code clones (referred to as Type-1 clones or exact clones) are code fragments that are identical to each other on a character-by-character level, allowing for possible variation in the use of whitespace characters, layout and comments. A second type of code clones (referred to as Type-2 clones or renamed clones) are code fragments that are identical to each other in the manner of Type-1 clones, but with variations in identifier names, types and literals. A third type of code clones (referred to as Type-3 clones or near miss clones) are code fragments that are structurally and/or syntactically similar to each other, but that different at the statement level (e.g., by statement modification, addition or deletion). A fourth type of code clones (referred to as Type-4 clones or semantic clones) are code fragments that differ in syntax but that have the same behavior or function.

Some background about existing techniques for code clone detection is now provided. Typically, existing code clone detection involves first preprocessing the source code. This preprocessing generally determines the granularity of clone detection. By granularity, it is meant the syntactic boundary for detecting a clone. A granularity at the block level means that a code clone is detected when two code blocks are clones of each other; similarly, a granularity at the method or function level means that a code clone is detected when two methods or functions are clones of each other. Clone detection can also have free granularity, meaning that there is no syntactic boundary for detecting clones. After the source code has been preprocessed to the desired level of granularity, the preprocessed code is typically transformed into some representation that can be used for clone detection. Most existing clone detection techniques can be divided into different categories depending on the representation used, such as text-based techniques (i.e., source code is analyzed as string sequence), token-based techniques (i.e., source code is analyzed as a sequence of tokens), AST-based techniques (i.e., source code is analyzed using abstract syntax trees (ASTs)), and PDG-based techniques (i.e., source code is analyzed using program dependency graphs (PDGs)).

However, existing clone detection techniques typically are designed for clone detection in small (e.g., software having tens of thousands lines of code) or moderately sized (e.g., software having less than one million lines of code) software programs, and are not scalable to larger software programs (e.g., software having several millions or even billions lines of code). By scalable, it is meant that clone detection can be completed for an entire software program within a reasonable amount of time (e.g., within one or two hours). For example, an existing clone detection technique known as Deckard (which is a AST-based technique) may be able to detect code clones in a moderately sized software program (e.g., having hundreds of thousands lines of code) in less than one minute, but would require over 12 hours to perform clone detection in a large software program (e.g., having tens of millions lines of code) and hence is not scalable. Further, many existing clone detection techniques suffer from the problem of low precision, thus resulting in a high number of false positives.

A current state-of-the art clone detection technique is known as VUDDY (e.g., described by Kim et al. “VUDDY: A Scalable Approach for Vulnerable Code Clone Discovery”, IEEE Symposium on Security and Privacy, 2017). VUDDY is a token-based clone detection technique, which is designed to detect Type-1 and Type-2 clones, at a method level granularity. However, VUDDY is not designed to detect Type-3 clones, and does not support clone detection at other granularity.

In various examples, the present disclosure describes example systems and methods that supports detection of Type-1, Type-2 or Type-3 clones, with a user-selectable granularity. The disclosed systems and methods may be scalable, such that clone detection in larger software programs (e.g., having hundreds of millions lines of code) can be completed within a practical time frame (e.g., within one to two hours or less).

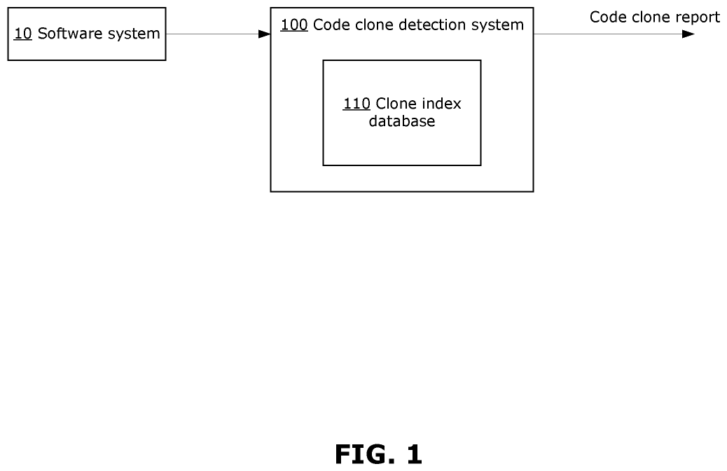

FIG. 1 is a block diagram illustrating an example code clone detection system 100, in accordance with examples of the present disclosure. The code clone detection system 100 may be implemented in a single physical machine or device (e.g., implemented as a single computing device, such as a single workstation, single server, etc.), or may be implemented using a plurality of physical machines or devices (e.g., implemented as a server cluster). For example, the code clone detection system 100 may be implemented as a virtual machine or a cloud-based service (e.g., implemented using a cloud computing platform providing a virtualized pool of computing resources). In some examples, the code clone detection system 100 may provide a clone detection service that is accessible by client devices (not shown in FIG. 1).

In FIG. 1, the code clone detection system 100 is in communication (e.g., over a network) with a software system 10. The software system 10 may be any computing device (e.g., server, end user device, workstation, etc.) storing a software program. In some examples, the software system 10 and the code clone detection system 100 may be implemented on the same computing device. The software system 10 provides a software program to the code clone detection system 100 for analysis.

The code clone detection system 100 in this example includes a clone index database 110. Although FIG. 1 illustrates the clone index database 110 as an internal database of the code clone detection system 100, in other examples the clone index database 110 may be an external database that is in communication with and maintained by the code clone detection system 100 (e.g., over a network). In some examples, the code clone detection system 100 may include one or more modules or subsystems for performing various functions of the code clone detection system 100 (e.g., for performing parsing functions, abstraction functions, normalization functions, n-gram generation functions, clone index generation functions and/or report generation functions, etc.). Operation of the code clone detection system 100 will be discussed in greater detail further below.

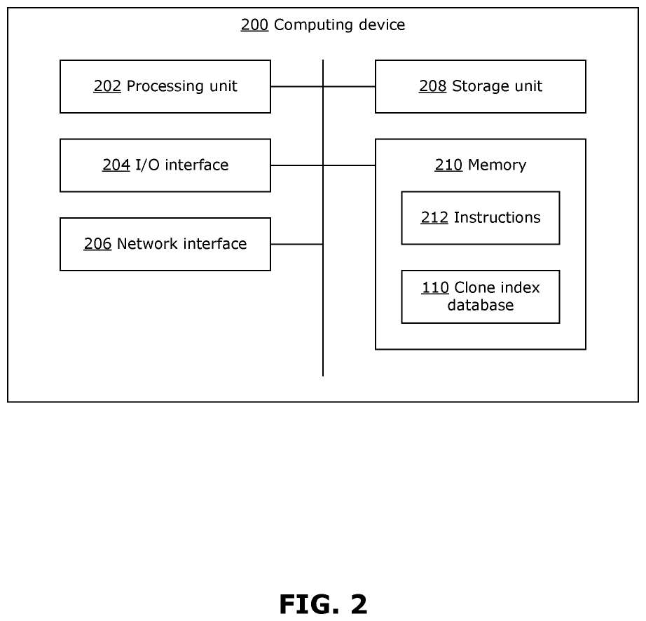

FIG. 2 is a block diagram illustrating a simplified example computing device 200 that may be used for implementing the code clone detection system 100, in some embodiments. The computing device 200 may represent a server or a workstation, for example. As discussed previously, the code clone detection system 100 may be implemented in other hardware configurations, including implementation using a plurality of computing devices or virtual machines. Although FIG. 2 shows a single instance of each component, there may be multiple instances of each component in the computing device 200.

In this example, the computing device 200 includes at least one processing unit 202, such as a processor, a microprocessor, a digital signal processor, an application-specific integrated circuit (ASIC), a field-programmable gate array (FPGA), a dedicated logic circuitry, a graphics processing unit (GPU), a hardware accelerator, or combinations thereof.

The computing device 200 may include an input/output (I/O) interface 204, which may enable interfacing with an input device and/or output device (not shown).

The computing device 200 may include a network interface 206 for wired or wireless communication with other computing devices or systems (e.g., the software system 10, etc.). The network interface 206 may include wired links (e.g., Ethernet cable) and/or wireless links (e.g., one or more antennas) for intra-network and/or inter-network communications. The network interface 206 may also enable the computing device 200 to communicate generated reports to another computing device (e.g., to a user device).

The computing device 200 may include a storage unit 208, which may include a mass storage unit such as a solid state drive, a hard disk drive, a magnetic disk drive and/or an optical disk drive.

The computing device 200 may include a memory 210, which may include a volatile or non-volatile memory (e.g., a flash memory, a random access memory (RAM), and/or a read-only memory (ROM)). The non-transitory memory 210 may store instructions for execution by the processing unit 202, such as to carry out example embodiments described in the present disclosure. For example, the memory 210 may store instructions 212 for implementing the code clone detection system 100 as well as any of the methods disclosed herein. The memory 210 may also store the clone index database 110. Alternatively, the clone index database 110 may be stored in the storage unit 208 or may be stored external to the computing device 200. The memory 210 may include other software instructions, such as for implementing an operating system and other applications/functions.

The computing device 200 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

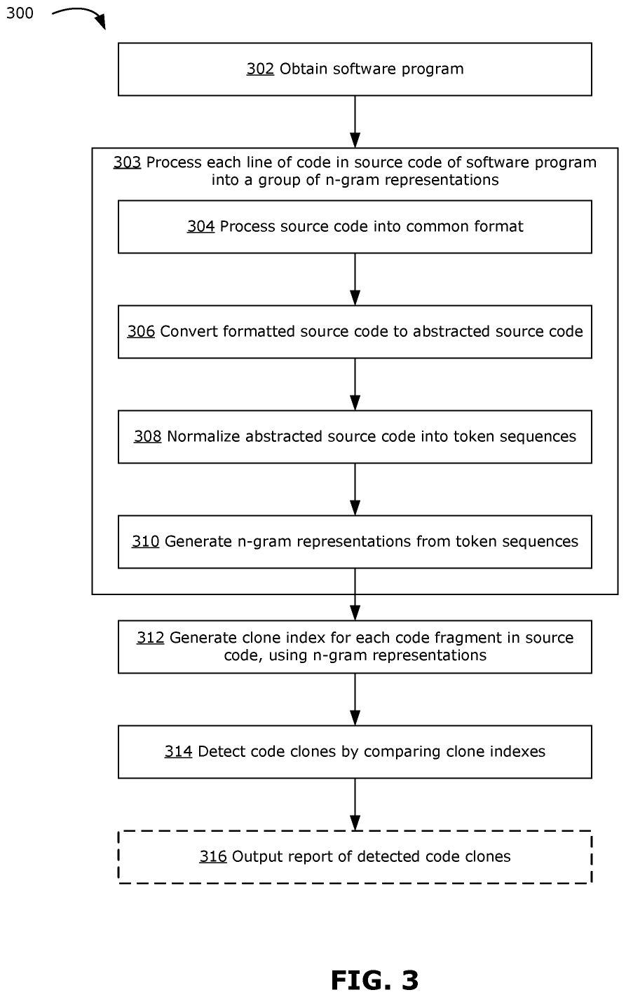

Detailed operation of the code clone detection system 100 is now discussed with reference to FIG. 3.

FIG. 3 is a flowchart illustrating an example method 300, which may be performed by the code clone detection system 100 (e.g., using any suitable modules and/or subsystems) to detect code clones in a software program. The method 300 may be implemented using the computing device 200, for example (e.g., instructions 212 for implementing the method 300 may be stored in the memory 210 and executed by the processing unit 202).

At 302, the code clone detection system 100 obtains a software program to be analyzed for code clones. For example, the software program may be obtained from the software system 10, for example by the software system 10 communicating the software program to the code clone detection system 100 for analysis. The software program contains source code, which may be in any coding language.

At 303, each line of code in the source code of the software program is processed into a respective group of n-gram representations. For example, step 303 may including steps 304, 306, 308 and 310 described below. It should be understood that different techniques may be used to process a line of code into a group of n-gram representations.

At 304, the source code of the software program is processed into a common format, such as the extensible markup language (XML) format. Parsing the source code into a common format enables the code clone detection system 100 to analyze the source code of the software program regardless of the coding language. The code clone detection system 100 may use any suitable parsing technique to parse the source code into the common format. For example, depending on the coding language used for the source code, the code clone detection system 100 may use the javalang library for parsing Java code, may use the pycparser for parsing C code, may use the PhASAR parser for parsing C++ code, or may use srcML to parse C, C++, C #or Java code into XML format. The coding language of the source code may be identified by the code clone detection system 100 (e.g., based on the extension or other identifier of the software program) and the appropriate parsing technique may be automatically selected. If the software program includes source code in multiple folders, the code clone detection system 100 may parse the source code from all folders into the common format. The source code in the common format may be referred to as formatted source code.

At 306, the code clone detection system 100 converts the formatted source code to abstracted source code. Converting the formatted source code to abstracted source code involves replacing specific identifiers in the formatted source code with generic (or abstract) identifiers. For example, a specific function identifier (i.e., the name of a function) in the formatted source code may be replaced with a generic label such as “function” or “FNAME” (i.e., function name).

The conversion to abstracted source code may be performed according to a selected abstraction level, which may be selected by a user (e.g., by an administrator of the code clone detection system 100, or by a client who desires detection of a certain type of code clone) or may be automatically selected by the code clone detection system 100 (e.g., a middle-range abstraction level may be selected by default). For example, a user-selected abstraction level may be provided as input to the code clone detection system 100 before, at the time of, or following step 302.

Different abstraction levels may be selected depending on the type of code clone to be detected and/or the desired maximum execution time. For example, a lower abstraction level may be limited to detecting only Type-2 clones that differ in function identifier but may result in faster execution time (i.e., the total time from obtaining the software program to outputting the code clone report may be shorter); conversely, a higher abstraction level may be able to detect Type-2 clones that differ in function identifier, variable identifier and/or literal identifier but may require longer execution time. In some examples, the abstraction level may be selected depending on the application. For example, a lower abstraction level may be suitable for detection of plagiarism or copyright infringement, whereas a higher abstraction level may be suitable for finding candidate code fragment to add to a code library.

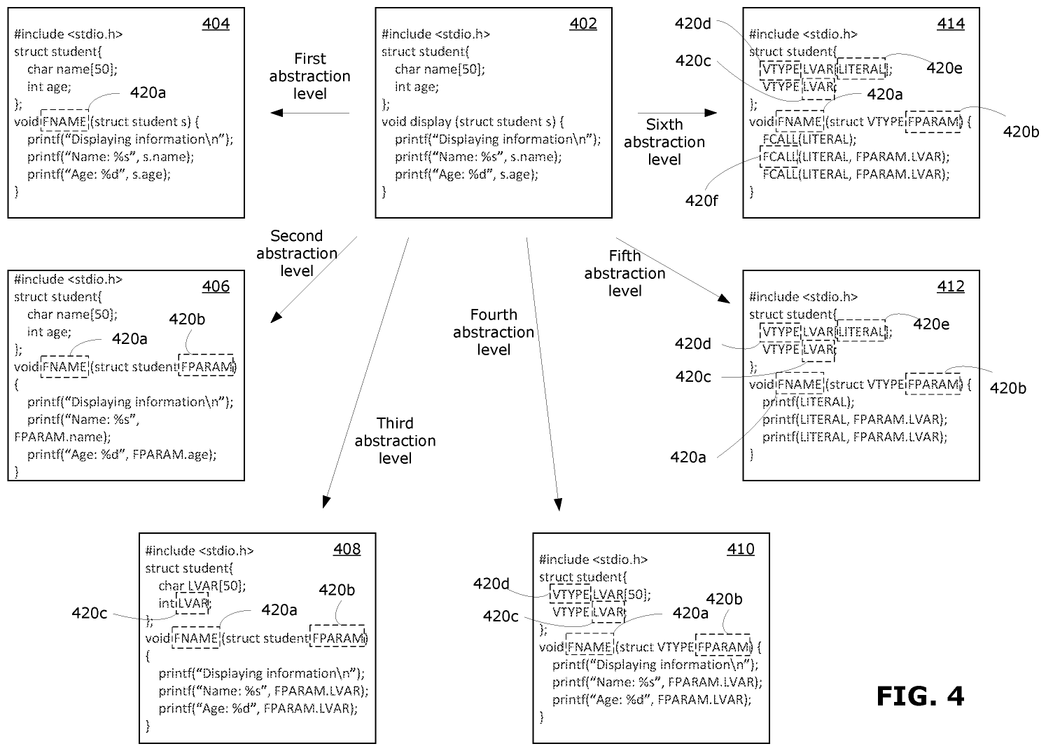

FIG. 4 illustrates examples of performing conversion from the formatted source code to the abstracted source code, according to six different abstraction levels. It should be understood that these abstraction levels are only exemplary and are not intended to be limiting.

FIG. 4 illustrates a simplified example source code 402, which has not been processed into a common format (e.g., XML format). It should be noted that, in the code clone detection system 100, the conversion to the abstracted source code is performed on the formatted source code in the common format; however, FIG. 4 shows the source code 402 before being proceed into the formatted source code, for simplicity. In this example, the conversion (e.g., replacement of specific identifier with a generic label) performed at any abstraction level includes all conversions (also referred to as abstractions) performed at all lower abstraction levels. For example, the conversion performed at the fourth abstraction level includes all conversions performed at the third, second and first abstraction levels. Thus, increasingly higher levels of abstraction results in abstracted source code that is increasingly more generic (while retaining the overall structure of the source code).

In the example shown, when a first abstraction level (which is the lowest abstraction level in this example) is selected, function identifiers in the formatted source code 402 are identified (e.g., based on parsing into the common format) and replaced with a generic label 420a such as FNAME in the first-level abstracted source code 404. When a second abstraction level is selected, in addition to the conversion performed at the first abstraction level, function parameter identifiers in the formatted source code 402 are identified (e.g., based on parsing into the common format) and replaced with a generic label 420b such as FPARAM (i.e., function parameter) in the second-level abstracted source code 406 (note that the second-level abstracted source code 406 also includes the generic label 420a replacing the function identifier).

When a third abstraction level is selected, global and local variable identifiers in the formatted source code 402 are identified (e.g., based on parsing into the common format) and replaced with a generic label 420c such as LVAR (i.e., global and local variable) in the third-level abstracted source code 408 (in addition to conversions performed at the first and second abstraction levels). When a fourth abstraction level is selected, variable type identifiers in the formatted source code 402 are identified (e.g., based on parsing into the common format) and replaced with a generic label 420d such as VTYPE (i.e., variable type) in the fourth-level abstracted source code 410 (in addition to conversions performed at the first to third abstraction levels). When a fifth abstraction level is selected, literal identifiers in the formatted source code 402 are identified (e.g., based on parsing into the common format) and replaced with a generic label 420e such as LITERAL (i.e., literal) in the fifth-level abstracted source code 412 (in addition to conversions performed at the first to fourth abstraction levels). When a sixth abstraction level (which may be the highest abstraction level) is selected, function call identifiers in the formatted source code 402 are identified (e.g., based on parsing into the common format) and replaced with a generic label 420f such as FCALL (i.e., function call) in the sixth-level abstracted source code 414 (in addition to conversions performed at the first to fifth abstraction levels).

Reference is again made to FIG. 3. In some examples, for detection of Type-1 clones, step 306 may be omitted (and optionally step 304 may also be omitted). For example, a selection of whether or not to perform conversion from the formatted source code to the abstracted source code (and optionally the abstraction level to use) may be provided as user input to the code clone detection system 100 before, at the time of, or following step 302. If some examples, if no abstraction is desired, step 306 may be performed using a zero-level abstraction as the selected abstraction level, and the abstracted source code may be simply be a copy of the formatted source code. In some examples, if no abstraction is desired, the abstracted source code may simply be a copy of the initial source code with whitespace, tabs and comments (and other non-functional characters) removed.

At 308, the abstracted source code is normalized into token sequences. For example, each line of code in the abstracted source code may be normalized into a respective token sequence. In some examples, the abstracted source code may be first normalized (e.g., in accordance with defined normalization rules) and then tokenized. Normalization may involve removing non-functional characters such as comments, tabs, and line feed characters. Functional symbol characters (e.g., brackets, semicolons, etc.) may also be removed. Whitespace characters may be preserved in the normalization, to maintain separation of identifiers and/or labels. Normalization may also involve correcting spelling errors that may be present in the identifiers. For example, a reference dictionary (such as a definition library that is associated with the software program) may be used to identify and correct spelling errors. Normalization may also involve converting all alphabetic characters into lowercase.

Tokenization may then be performed on each line of the normalized source code. Any suitable tokenization algorithm may be used (e.g., tokenization algorithms that have been developed for natural language processing (NLP) applications may be adapted for use by the code clone detection system 100). The result is that each line of normalized source code is represented by a respective token sequence that includes tokenized identifiers and labels from the normalized source code. The token sequence may represent the respective line of code in a format that is suitable for the next step in the method 300. Notably, the token sequence preserves the sequence of identifiers and labels in the line of code. For a plurality of lines of code, step 308 generates a respective plurality of token sequences.

At 310, n-gram representations are generated from the token sequences. Specifically, one or more n-gram representations are generated from each token sequence representing a respective line of code in the normalized source code. Thus, each line of code corresponds to a group of one or more n-gram representations.

An n-gram is a subsequence of n tokens from a token sequence, where n is a positive integer. It should be noted that n-grams generated from a token sequence may contain overlapping tokens. For example, if the token sequence for a given line of code is the sequence “public static vtype funcname vtype fparam throws exception” and n is four, then five different 4-grams are generated for the given line of code as follows: “public static vtype funcname”, “static vtype funcname vtype”, “vtype funcname vtype fparam”, “funcname vtype fparam throws”, and “vtype fparam throws exception”. In some examples, if the number of tokens in the token sequence is shorter than n (e.g., there are only two tokens in a line of code and n is four), then generation of an n-gram representation for that token sequence may include padding the n-gram representation with blank tokens (or other user-defined token).

The size of the n-gram representations (i.e., the value of n) may affect the granularity of the clone detection and may also affect the execution time. For example, if n-gram representation is a smaller size (e.g., 1-gram or 2-gram representations), the execution time may be higher due to the greater number of n-grams to be processed and the granularity may be smaller. Conversely, if n-gram representation is a larger size (e.g., 6-gram or 7-gram representations), the execution time may be lower since there will be fewer n-grams per token sequence (corresponding to a line of code), however the granularity may be coarser. Using n-gram representation enables the source code to be represented in a way that captures the contextual information, while also controlling for a desire level of granularity in the clone detection.

The size of the n-gram representations may be selected by a user (e.g., by an administrator of the code clone detection system 100, or by a client who desires clone detection at a certain granularity) or may be automatically selected by the code clone detection system 100 (e.g., selecting a value of n=4 has been empirically found to be suitable for most software programs). For example, a user-selected granularity level may be provided as input to the code clone detection system 100 before, at the time of, or following step 302.

Regardless of whether step 303 is performed using steps 304-310, or some other technique, after each line of code has been processed into a corresponding group of n-gram representations, the method 300 proceeds to step 312.

At 312, a clone index is generated for each code portion defined in the source code, using the n-gram representations. Each clone index is generated from a collection of n-gram representations corresponding to a defined code portion (e.g., a collection of all n-gram representations found in a defined number of lines of code). The clone index includes a feature vector (which may be a binary vector, a hash vector or other fixed-size vector representation) that encodes features extracted from the corresponding code portion, based on the n-gram representations. The clone index may associate the feature vector with an identifier of the software program (e.g., the file name of the source code) and an identifier of the corresponding code portion (e.g., a line index indicating the start of the code portion). The feature vector may be used as a fingerprint that uniquely represents the code portion in the source code.

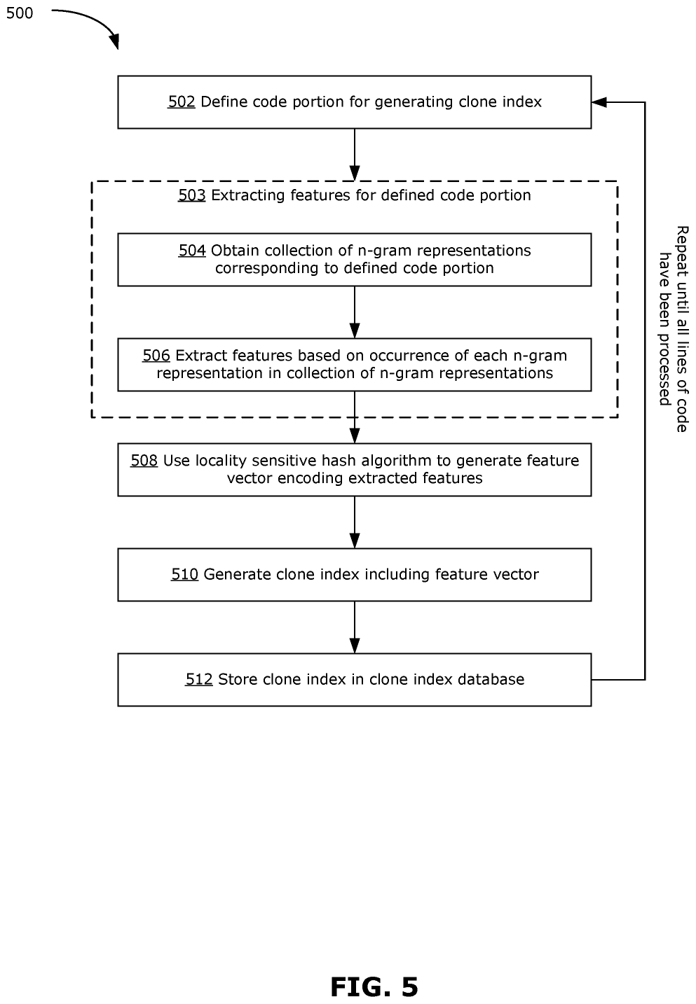

FIG. 5 is a flowchart illustrating an example method 500 that may be used at step 312 for generating the clone index for each code portion. In this example, it may be assumed that step 303 was performed by performing steps 304-310, although this is not intended to be limiting.

At 502, a code portion is defined for which the clone index is generated. For example, the code portion may be a defined number of lines of code (e.g., five lines of code). The code portion may be defined according to a sliding window, which shifts by one line of code in each iteration of the method 500. For example, the defined code portion may be lines 1-5 of the normalized source code in the first iteration, then in the next iteration the defined code portion may be lines 2-6. For example, the defined code portion may be defined by a defined window size (e.g., 5 lines of code) and by a defined line index (e.g., according to the code line numbering in the source code) indicating the first line of code within the window. The method 500 will be discussed with respect to generating a clone index for a given code portion defined in step 502.

The size of the sliding window may affect the granularity of clone detection (e.g., a larger window size may result in coarse granularity), with a tradeoff in execution time (e.g., a larger window size may result in faster execution). The size of the sliding window may be defined by a user (e.g., by an administrator of the code clone detection system 100, or by a client who desires clone detection at a certain granularity) or may be automatically defined by the code clone detection system 100 (e.g., a window size of 5 lines of code has been empirically found to be suitable for most software programs). For example, a user-defined window size may be provided as input to the code clone detection system 100 before, at the time of, or following step 302.

At 503, features are extracted for the defined code portion. The extracted features are based on the n-gram representations corresponding to the given code portion. For example, performing step 503 may including performing steps 504 and 506. However, it should be understood that other feature extraction techniques may be used to perform step 503.

At 504, a collection of n-gram representations corresponding to the defined code portion is obtained. For example, if the defined code portion is defined by a defined window size and a defined line index, then the groups of n-gram representations corresponding to the lines of code (i.e., consecutive lines of code starting from the defined line index to the last line within the defined the window size) in the defined code portion are included in the collection of n-gram representations. For example, if the defined code portion is lines 1-5 of the normalized source code, then the obtained collection of n-gram representations would be the groups of n-gram representations corresponding to each of lines 1-5.

At 506, features are extracted from the collection of n-gram representations, based on the occurrence of each n-gram representation in the collection. For example, the number of instances of each n-gram representation in the collection is counted. Each n-gram representation may be considered to be a feature of the collection, and the count of each n-gram representation may then be considered as the weight of that respective feature. It should be understood that other techniques for feature extraction may be used. For example, the weight of a feature may be user-defined (e.g., a user may define a feature extraction rule where a greater weight is assigned to a feature if that feature is an n-gram that contains a token of interest). Other techniques for extracting features from the collection of n-gram representations may be used. For example, extracting features from the collection of n-gram representations may not involve determining a weight of each feature (where each n-gram representation is a respective feature of the collection). That is, the feature extraction may extract features that simply represent the occurrence of a given feature without representing the count or other weighting factor associated with the given feature.

Regardless of how step 503 is performed, after extracting features for the defined code portion the method 500 proceeds to step 508.

At 508, a locality sensitive hash (LSH) algorithm is used to generate a feature vector encoding the extracted features. In particular, a weighted hash vector may be generated for each respective extracted feature. For example, a hash algorithm (e.g., MD5 or SHA-1) may be used to generate a hash value for each n-gram representation in the collection. It should be noted that the hash algorithm used to generate the hash value may not be a LSH algorithm, however the generated hash value is used in step 508 in a way that encodes locality sensitive information. The hash value may be represented as a binary vector of fixed size, and may be referred to as the hash vector. For each given n-gram representation, the weight of the given n-gram representation is applied to the hash vector for the given n-gram representation, to obtain a weighted hash vector for the given n-gram representation. For example, the hash vector for the given n-gran representation may be multiplied by the weight of that n-gram representation (where zero entries in the hash vector may be treated as having a value of −1). The weighted hash vectors for all n-gram representations in the collection are then combined (e.g., summed) to obtain a combined vector that represents the overall extracted features and corresponding feature weights in the collection of n-gram representations.

The combined vector may be used as the feature vector that is used for the clone index. In some examples, the combined vector may be converted to a binary combined vector, where a zero or negative entry in the combined vector is converted to a ‘0’ entry in the binary combined vector and a positive entry in the combined vector is converted to a ‘1’ entry in the binary combined vector. The binary combined vector may then be used as the feature vector for the clone index. Using the binary combined vector instead of the original combined vector as the feature vector may help to reduce the memory resources used to store the clone indexes, since binary values require fewer bits to store compared to non-binary values.

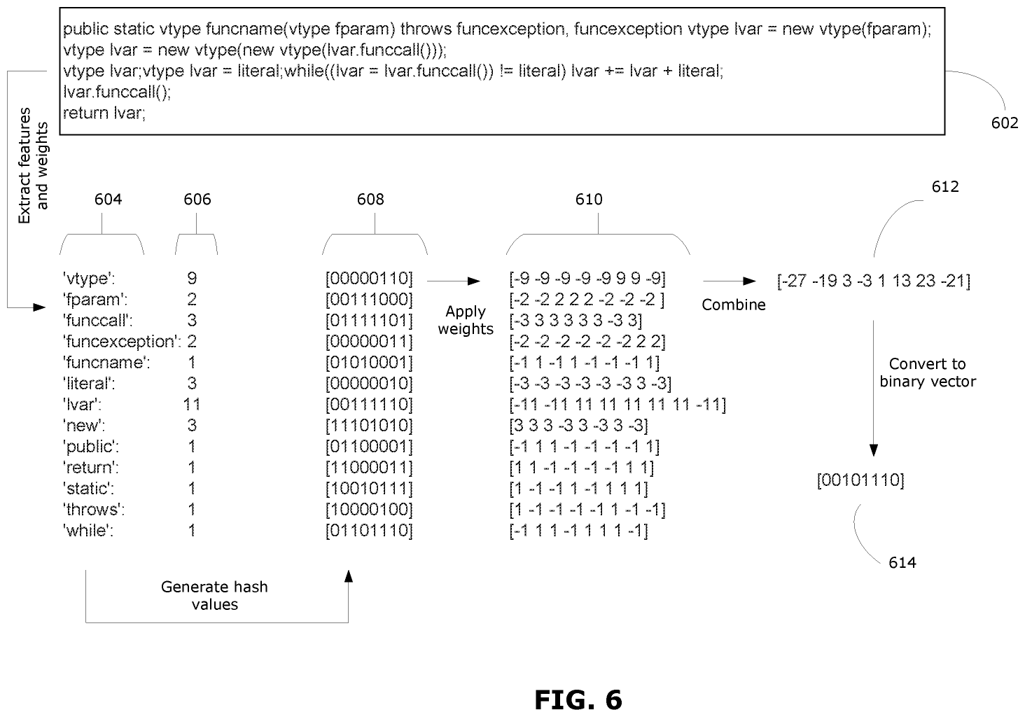

FIG. 6 illustrates an example of how a feature vector may be generated for a defined code portion, using steps 506 and 508 described above.

In this example, the defined code portion 602 consists of five lines of code. As described for step 506, features and corresponding weights of the defined code portion 602 are extracted. In this example, the extracted features 604 are 1-gram representations (i.e., in this example, n=1 for the n-gram representations) in the defined code portion 602, and the corresponding weights 606 are the counts of the respective features 604 in the defined code portion 602. For example, the 1-gram representation ‘vtype’ occurs nine times in the defined code portion 602, so the corresponding weight 606 for the feature 604 ‘vtype’ is nine. As previously mentioned, in some examples weights 606 for the features 604 may not be determined (or equivalently every feature 604 may have a weight 606 of ‘1’).

As described for step 508, hash values are generated for the respective features 604 using a suitable hash algorithm. The hash values are represented in this example as fixed size binary hash vectors 608. For example, the hash vector 608 [00000110] is generated for the feature 604 ‘vtype’. The respective weight 606 of each given feature 604 is applied to the respective hash vector 608, to obtain the weighted hash vectors 610. In this example, a zero entry in the hash vector 608 is treated as a value of −1 when applying weights. For example, the hash vector 608 [00000110] for the feature 604 ‘vtype’ is multiplied by the respective weight 606 (i.e., nine), to obtain the weighted hash vector 610 [−9 −9 −9 −9 −9 9 9 −9]. The weighted hash vectors 610 for all the features 604 are then combined into a single combined vector 612, in this example by summing all the weighted hash vectors 610 (in examples where the weights 606 are not determined, the single combined vector 612 may be generated by combining the hash vectors 608, such as by summing all the hash vectors 608). The combined vector 612 may be used as the feature vector to be included in the clone index for the defined code portion 602. Alternatively, the combined vector 612 may further be converted to the binary combined vector 614 (e.g., by converting all non-positive entries in the combined vector 612 to ‘0’ and all positive entries in the combined vector 612 to ‘1’). The binary combined vector 614 may then be used as the feature vector to be included in the clone index for the defined code portion 602.

Reference is again made to FIG. 5. At 510, the clone index for the defined code portion is generated, including the feature vector. The clone index may be a tuple having three elements, namely an identifier of the source code (e.g., file name) to which the code portion belongs, an indicator of the location of the code portion within the source code (e.g., a line index indicating the location of the first line of the code portion in the source code), and the feature vector.

At 512, the clone index for the defined code portion is stored in the clone index database 110. The method 500 may be repeated for the next code portion (e.g., defined by the sliding window), until all lines of code in the normalized source code have been processed.

After processing all of the normalized source code using the method 500, the clone index database 110 contains clone indexes generated for each code portion defined in the normalized source code. Each clone index includes an identifier of the source code, an indicator of the location of the respective code portion within the source code (e.g., the line index for the first line of each code portion), and a feature vector that encodes the features of the respective code portion based on the n-gram representations from the respective code portion.

The clone index database 110 may store clone indexes for multiple different software programs, to enable code clones to be detected across multiple different software programs. Alternatively, the clone index database 110 may be specific to a single software program (e.g., there may be multiple clone index databases 110, each cone index database 110 being specific to a respective software program), to enable code clones to be detected only within the single software program. It should be noted that, even if the clone index database 110 stores clone indexes for multiple different software programs, the clone index database 110 may be searched for code clones within a single given software program, by searching for clone indexes containing the identifier for the given software program.

In order for the clone indexes in the clone index database 110 to be comparable for clone detection, it is necessary that the clone indexes all be generated using the same process. For example, the same window size, feature extraction technique and LSH algorithm should be used for generating all the clone indexes in the clone index database.

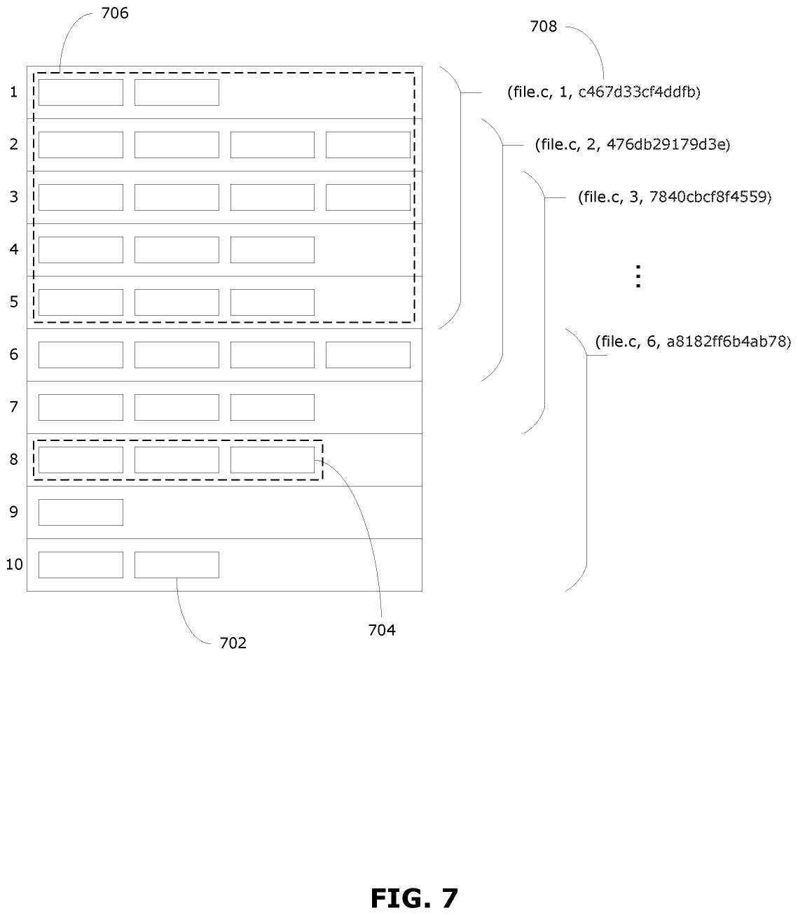

FIG. 7 illustrates a simplified example of how clone indexes may be generated for a normalized source code.

In this simple example, the normalized source code contains 10 lines of code, indexed from 1 to 10. It should be understood that normalized source code that would be generated from a moderately sized software program would have thousands of lines of code. Each line of code has a corresponding group of n-gram representations 702. Notably, there may be more than one n-gram representation 702 corresponding to one line of code. For example, there are three n-gram representations 702 in the group 704 corresponding to line 8.

In this example, a code portion is defined using a sliding window, where the window size is five lines of code. Thus, a first code portion is lines 1-5 of the normalized source code, a second code portion is lines 2-6 of the normalized source code, and so forth until the last code portion that is lines 6-10 of the normalized source code.

For each code portion, a feature vector is generated from the corresponding collection of n-gram representations as described above. In particular, the collection of n-gram representations for a given code portion is the collection of all n-gram representations corresponding to all lines of code in the given code portion. For example, for the first code portion corresponding to lines 1-5, the collection 706 of n-gram representations consists of all n-gram representations 702 corresponding to lines 1-5 of the normalized source code. The feature vector representing the n-grams in the first code portion is generated from the collection 706 of n-gram representations corresponding to lines 1-5 of the normalized source code. Using the generated feature vector, the clone index 708 for the first code portion is generated. In this example, the clone index 708 includes an identifier of the source code (e.g., the file name “file.c”), an indicator of the location of the first code portion (e.g., the index of the first line of code in the code portion, namely the index “1”), and the feature vector that was generated (in this example, the feature vector is represented by the hexadecimal value “c467d33cf4ddfb”).

The clone indexes for other code portions are also shown in FIG. 7. Notably, the code portions contain overlapping lines of code but the feature vectors uniquely encode features of each code portion based on the n-gram representations belonging to each code portion. In other words, if two feature vectors for respective two different code portions are identical, then this means that the n-gram based features of the two code portions are the same and hence the two code portions should be considered clones of each other.

Reference is again made to FIG. 3. After clone indexes have been generated for the code portions in the source code, and the generated clone indexes have been stored in the clone index database 110, the method 300 proceeds to step 314.

At 314, code clones are detected by comparing the clone indexes in the clone index database 110 with each other. In particular, the feature vectors included in each clone index is used as a fingerprint for identifying each code portion. If two fingerprints are identical, the corresponding two code portions are considered to be a code clone pair. Comparison of feature vectors to find code clone pairs may be performed using any suitable matching algorithm, such as any suitable string matching algorithm.

When using the clone indexes to detect code clones, the code clone detection system 100 may identify the largest possible code fragment that is a detected code clone (i.e., largest number of consecutive lines of code that are considered to be a code clone). For example, having found a first code portion that matches the fingerprint of a second code portion, the code clone detection system 100 may then determine if a third code portion sequentially following the first code portion also matches the fingerprint of a fourth code portion sequentially following the second code portion. If the fingerprints of the third and fourth code portions match, then the size of the code clone is increased to encompass this matched pair. In this way, the code clone detection system 100 is not limited to detecting code clones that are the same size as the sliding window used to define code portions at step 502, but is able to detect larger-sized clones.

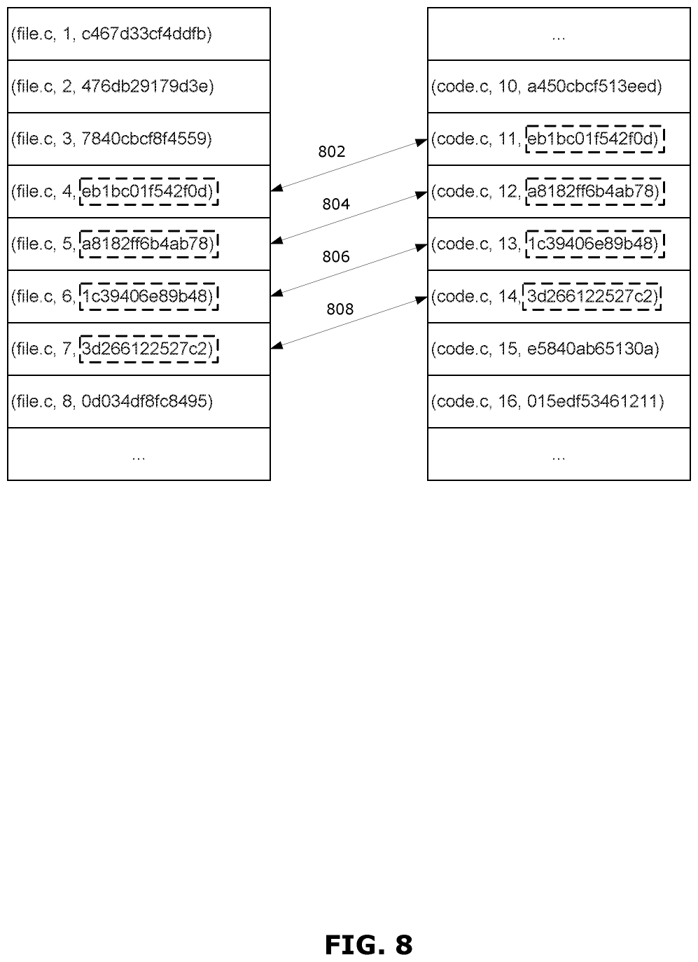

FIG. 8 illustrates an example of how the clone indexes may be used to identify the largest possible code fragment for a detected code clone.

In this example, the clone index database 110 is being used to detect code clones in a first software program “file.c”. FIG. 8 shows an example where the clone index database 110 includes clone indexes for the first software program “file.c” and also includes clone indexes for a second software program “code.c”. For example, the clone indexes for code.c may have been previously generated when code.c was previously analyzed for code clones.

In this example a first match 802 has been found based on a matched fingerprint (indicated by dashed lines in FIG. 8) between the indexes (file.c, 4, eblbc01f542f0d) and (codex, 11, eb1bc01f542f0d). That is, the code portion starting a line 4 of file.c is found to be a code done of the code portion staring at line 11 of codec.

Having found a first match 802, the code clone detection system 100 evaluates the clone indexes for the pair of next sequential code portions. In this case, the next sequential code portions is the code portion starting at line 5 of file.c and the code portion starting at line 12 of code.c. As shown in FIG. 8, it is found that the pair of next sequential code portions also have matching fingerprints and thus is another match 804. In this manner, additional matches 806 and 808 may be found for pairs of sequential code portions, until the fingerprints no longer match between a pair of sequential code portions (e.g., the fingerprint for the code portion starting at line 8 of file.c does not match the fingerprint for the code portion starting at line 16 of code.c).

The largest possible code fragment that is a detected code clone in file.c in this example is thus from the first line of the first match 802 to the last line of the last match 808. This means that the detected code clone in file.c consists of lines 4-11 of file.c (which is considered to be a code clone of lines 11-18 of code.c), assuming each clone index represents a 5-line code portion. This matching process may be performed for all clone indexes of file.c, to detect any additional code clones in file.c.

Reference is again made to FIG. 3. After performing step 314, the code clone detection system 100 has detected all code clones for a given software program. Detected code clones may include a code fragment in the given software program that is a clone of a code fragment in a different software program or in the same given software program. For example, the clone indexes associated with (i.e., generated from) a given software program may be compared with the clone indexes associated with (i.e., generated from) the same given software program, and may also be compared with the clone indexes associated with (i.e., generated from) another software program. For example, clone indexes that are generated for code clone detection in any software program may be stored in the clone index database 110 long-term (e.g., stored for an extended period of time, such as five years or longer) to enable detection of code clone across different software programs.

Optionally, at 316, the code clone detection system 100 may generate and/or output a report of any and all detected code clones in the given software program. For example, the report may include individual entries for each detected code clone, where each entry includes an identifier of the software program being analyzed (i.e., the given software program that was obtained at step 302), an identifier of a second software program where a clone was found (which may be the same given software program or a different software program), an indicator of the location of the cloned code fragment in the given software program (e.g., line indexes of the first and last lines of the code fragment), and an indicator of the location of the corresponding identical or similar code fragment in the second software program (e.g., line indexes of the first and last lines of the corresponding code fragment).

For example, for the code fragment that was found to be a code clone in the example of FIG. 8, the code clone report generated by the code clone detection system 100 may include the following entry:
(file.c, 4, 11, code.c, 11, 18)

Any other format may be used for reporting a detected code clone.

The code clone report may be outputted to another computing device or system. For example, the code clone report may be outputted to the software system 10 that was the source of the software program and/or may be outputted to a client device.

In some examples, steps of the method 300 may be repeated to analyze a given software program at different abstraction levels and/or at different granularity. For example, step 306 may be repeated for different selected abstraction levels, to generate multiple versions of the abstracted source code (each at a different abstraction level) for the same given software program. Similarly, multiple sets of clone indexes for the same given software program can be generated, where each set of clone indexes results from a certain selected window size. In this way, different types of clones (e.g., Type-1, Type-2 or Type-3 clones) can be detected at different levels of granularity for a given software program, and the results may all be included in a single code clone report for the given software program.

In some examples, the code clone report or entries in the code clone report may also be stored by the code clone detection system 100. For example, the code clone detection system 100 may maintain a table containing entries of detected clones. At regular intervals or in response to user input, the code clone detection system 100 may identify code fragments that are associated with a high number of detected code clones. Such identified code fragments may be candidates for inclusion in a code library, for example.

The code clone detection system 100 may be used for detection of code clones in various applications. For example, clone indexes may be generated for a code unit (e.g., a function or a file) that is known to be malicious or known to have vulnerabilities. The code clone detection system 100 may then be used to detect if there is any code fragment in a given software program that is a clone of the malicious or vulnerable code unit, to enable a software developer to make appropriate remedies. In another example, the code clone detection system 100 may be used for detection of plagiarism or copyright infringement by comparing the clone indexes generated for two software programs.

In another example, the code clone detection system 100 may be used to compare two versions of a software program, or two merged software branches. Such a comparison may be useful for identifying opportunities for refactoring. Detection of all code clones present in a software system may also help in understanding overall operation of the software system.

The disclosed systems and methods may provide advantages over existing code clone detection techniques such as VUDDY. For example, VUDDY support method level clone detection only, whereas examples of the disclosed systems and methods enable detection of clones at selectable granularity levels. For example, if it is desired to detect clones at the single-line level, it is possible to do so by controlling the window size used to define the code portion from which a clone index is generated. This may enable detection of code clones where clones are found at the line-level rather than the larger method-level.

Further, whereas VUDDY (and some other existing clone detection techniques) use token-based clone detection, examples of the disclosed systems and methods make use of n-grams, which capture contextual information in a token sequence. The use of n-grams with LSH may support the detection of Type-3 clones (in addition to detection of Type-1 and Type-2 clones, which are also supported by examples of the disclosed systems and methods).

The use of LSH may enable creation of a more efficient clone index database, compared to solutions that store the tokens themselves, since using LSH results in a fixed size hash that may require fewer memory resources to store and process compared to tokens. The use of LSH may thus help to address scalability issues.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processor device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
obtaining a software program comprising source code;
processing the source code into groups of n-gram representations, each group of n-gram representation corresponding to a respective line of code in the source code;
generating a clone index for each respective code portion defined in the source code, each respective code portion comprising a defined number of lines of code, wherein each clone index includes a feature vector encoding features of the respective code portion based on the n-gram representations corresponding to the respective code portion; and
detecting a code clone based on matching the feature vectors of the clone indexes by comparing the clone indexes.

2. The method of claim 1, further comprising:
outputting a code clone report including an entry indicating the detected code clone.

3. The method of claim 1, wherein processing the source code into the groups of n-gram representations comprises:
processing the source code into formatted source code having a common format;
converting the formatted source code into abstracted source code according to an abstraction level;
normalizing the abstracted source code into normalized source code comprising token sequences, wherein each token sequence corresponds to a respective line of code in the normalized source code and wherein each line of code in the normalized source code corresponds to a respective line of code in the source code; and
generating, for each token sequence, the group of n-gram representations corresponding to the respective line of code.

4. The method of claim 3, wherein converting the formatting source code into the abstracted source code comprises:
obtaining a selection of the abstraction level, wherein the abstraction level defines one or more types of identifiers in the formatted source code to be replaced with respective generic labels; and
replacing the defined one or more types of identifiers in the formatted source code with the respective generic labels, to obtain the abstracted source code.

5. The method of claim 4, wherein the abstraction level is selectable by user input.

6. The method of claim 1, wherein the defined number of lines of code is selectable by user input.

7. The method of claim 1, wherein generating the clone index for a given code portion comprises generating the feature vector encoding features of the given code portion, wherein generating the feature vector comprises:
extracting features from the given code portion based on the n-gram representations corresponding to the given code portion;
for each feature, generating a respective weighted hash vector; and
combining the weighted hash vectors into a combined vector for use as the feature vector.

8. The method of claim 7, wherein extracting features from the given code portion comprises:
obtaining a collection of n-gram representations corresponding to the given code portion by collecting the group of n-gram representations corresponding to each line of code belonging to the given code portion; and
extracting the features from the given code portion, wherein each n-gram representation in the collection of n-gram representations is a feature of the given code portion, and wherein a count of each feature within the collection of n-gram representations is a respective weight.

9. The method of claim 7, wherein generating the respective weighted hash vector for each feature comprises:
for each feature, generating a respective hash vector using a hash algorithm; and
for each hash vector corresponding to a respective feature, applying the respective weight to obtain the respective weighted hash vector.

10. The method of claim 7, wherein the combined vector is further converted to a binary combined vector for use as the feature vector.

11. The method of claim 1, wherein the clone index for a given code portion comprises an identifier of the source code, an indicator of a location of the given code portion in the source code, and the feature vector encoding features of the given code portion.

12. The method of claim 1, wherein each code portion defined in the source code is defined by using a sliding window, the defined number of lines of code in each code portion being defined by a size of the sliding window.

13. The method of claim 1, further comprising:
storing the clone indexes in a clone index database.

14. The method of claim 1, wherein detecting the code clone comprises comparing the clone indexes associated with the software program with clone indexes associated with another software program.

15. A device comprising:
a processing unit configured to execute instructions to cause the device to:
process a source code into groups of n-gram representations, each group of n-gram representation corresponding to a respective line of code in the source code;
generate a clone index for each respective code portion defined in the source code, each respective code portion comprising a defined number of lines of code, wherein each clone index includes a feature vector encoding features of the respective code portion based on the n-gram representations corresponding to the respective code portion; and
detect a code clone based on matching the feature vectors of the clone indexes by comparing the clone indexes.

16. The device of claim 15, wherein the processing unit is configured to execute the instructions to further cause the device to:
output a code clone report including an entry indicating the detected code clone.

17. The device of claim 15, wherein the processing unit is configured to execute the instructions to further cause the device to process the source code into the groups of n-gram representations by:
processing the source code into formatted source code having a common format;
converting the formatted source code into abstracted source code according to an abstraction level;
normalizing the abstracted source code into normalized source code comprising token sequences, wherein each token sequence corresponds to a respective line of code in the normalized source code and wherein each line of code in the normalized source code corresponds to a respective line of code in the source code; and
generating, for each token sequence, the group of n-gram representations corresponding to the respective line of code.

18. The device of claim 17, wherein the processing unit is configured to execute the instructions to further cause the device to convert the formatting source code into the abstracted source code by:
obtaining a selection of the abstraction level, wherein the abstraction level defines one or more types of identifiers in the formatted source code to be replaced with respective generic labels; and
replacing the defined one or more types of identifiers in the formatted source code with the respective generic labels, to obtain the abstracted source code.

19. The device of claim 15, wherein the processing unit is configured to execute the instructions to further cause the device to generate the clone index for a given code portion by generating the feature vector encoding features of the given code portion, wherein generating the feature vector comprises:
extracting features from the given code portion, based on the n-gram representations corresponding to the given code portion, by:
obtaining a collection of n-gram representations corresponding to the given code portion by collecting the group of n-gram representations corresponding to each line of code belonging to the given code portion; and
extracting the features from the given code portion, wherein each n-gram representation in the collection of n-gram representations is a feature of the given code portion, and wherein a count of each feature within the collection of n-gram representations is a respective weight;
for each feature, generating a respective weighted hash vector; and
combining the weighted hash vectors into a combined vector for use as the feature vector.

20. A non-transitory computer readable medium having instructions encoded thereon, wherein the instructions, when executed by a processing unit of a device, cause the device to:
process a source code into groups of n-gram representations, each group of n-gram representation corresponding to a respective line of code in the source code;
generate a clone index for each respective code portion defined in the source code, each respective code portion comprising a defined number of lines of code, wherein each clone index includes a feature vector encoding features of the respective code portion based on the n-gram representations corresponding to the respective code portion; and
detect a code clone based on matching the feature vectors of the clone indexes by comparing the clone indexes.
